(19) United States
(12) Patent Application Publication
(10) Pub. No.: US 2007/0294273 A1
(43) Pub. Date: Dec. 20, 2007

(54) METHOD AND SYSTEM FOR CATALOGING MEDIA FILES

(75) Inventors: MAURICIO A. BENDECK, MIAMI, FL (US); JAMES C. FERRANS, WHEATON, IL (US); JOSE E. KORNELUK, LAKE WORTH, FL (US); VON A. MOCK, BOYNTON BEACH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/424,697

(22) Filed: Jun. 16, 2006

(51) Int. Cl. G06F 17/00

(52) U.S. Cl. 707/101

(57) ABSTRACT

A system (100) and method (700) for capturing and cataloguing media filenames can include a media capturing device (101, 102 or 103), a context input device (106) for a providing a context value associated with at least one media file, and a processor (106) coupled to the context input device. The processor can be programmed to apply the context value to a media filename or a group of media filenames. The media capturing device can be a digital camera, a digital audio recording device, a digital video camera, a camera phone, or a portable computing device with any combination thereof. The context input device can include a voice capturing device and the system can further include a voice to text converter and tagging engine for tagging textual representations of captured voice associated with media captured by the media capturing device.

### FIELD

This invention relates generally to file cataloging of media files, and more particularly to a method and system of providing a file cataloging system.

### BACKGROUND

Pictures taken with digital cameras, camera phones, and other digital recorders, by default, have a file name or picture file name naming convention that automatically upon the picture being taken records the file name to the data set of that naming convention file format, e.g. B0002345.jpg. When pictures are transferred or downloaded from any digital recorder onto a personal computer or sent via cellular MMS (multimedia messaging system), the file name default is the last numbering schema data set, e.g. B00023456.jpg. This picture file naming convention is a problem for users who cannot change the name of the picture file in the digital recorder until the pictures have been first downloaded to a personal computer. It is an arduous user process to rename each individual file name to a name that will closely associate the event taken place when the picture was taken. Such a scenario further compounds the problem when a catalog of those pictures is created and logical and user friendly searches for such pictures and/or catalogs are subsequently desired.

### SUMMARY

Embodiments in accordance with the present invention can provide a user friendly system of creating and cataloging media file names that might be difficult to track without additional context.

In a first embodiment of the present invention, a method of cataloging a media file name can include obtaining a context reference and dynamically applying the context reference to the media file name. The method can further include converting the context reference to a text representation and tagging the media file name with the text representation. Obtaining the context reference can involve obtaining a voice print, a face recognition, an image recognition, a text recognition, an emotional state, a physiological state, or a voice tag as examples. The context reference can also be a temporal context or a location context. The location context can be for example GPS information, or beacon identifier information or local area network data information or metadata or a Bluetooth friendly name from a localized wireless source. The context reference can generally be a reference that will likely be more recognizable to a user or allow the user to associate additional information with a media file than a simple numeric reference. Dynamic application of the context reference to the media file can mean applying the context reference to the media file while the media file is being created or after the media is created. In some instances, it can also technically mean applying the context reference before the media is created. For example, applying calendaring information to a media file as discussed further below can be thought of as being applied before creation of the media.

The context reference can also be calendaring data where in one embodiment the calendaring data can be applied to the media file name if temporal or location values are within thresholds of the calendaring data and where other names (such as a default name) are applied to the media file name if temporal or location values exceed one or more thresholds of the calendaring data. Furthermore, a new context reference can be created and applied to a currently acquired media file if temporal or location values exceed one or more thresholds for the calendaring data. The method can also include the step of voice cataloging a currently acquired media file with a voice tag. The voice tag can be translated into text and applied to the media file name. Note, the media file name can be for a currently acquired data file for a picture file, a video file, or an audio file, but is not necessarily limited thereto. “Media” in this context can also be thought of as a data file for a picture file, a video file, or an audio file, but again is not necessarily limited thereto. The method can further include the steps of creating a catalog group based on the context reference, using calendaring data to name the catalog group, optionally inserting a past appointment into the calendaring data to mark a past activity, and using temporal or spatial information to create subgroups within a catalog group.

In a second embodiment of the present invention, a system for capturing and cataloguing media filenames can include a media capturing device, a context input device for a providing a context value associated with at least one media file, and a processor coupled to the context input device. A context value can be synonymous with a context reference as discussed above. The processor can be any suitable component or combination of components, including any suitable hardware or software, that are capable of executing the processes described in relation to the inventive arrangements herein. The processor can be programmed to apply the context value to a media filename or a group of media filenames. The media capturing device can be a digital camera, a digital audio recording device, a digital video camera, a camera phone, or a portable computing device with any combination thereof. The context input device can include a voice capturing device and the system can further include a voice to text converter and tagging engine for tagging textual representations of captured voice associated with media captured by the media capturing device. The context input device can alternatively include a voice recognition device, an image recognition device, an optical character recognition device, an emotional state monitor, or a physiological state monitor. The context input device can also alternatively include a temporal and location capturing device or a calendaring device coupled to the processor. In yet another alternative, the context input device can include a GPS receiver, a beacon receiver, or a local area network receiver.

In a third embodiment of the present invention, a media capturing device can include an image or sound capturing device that creates data files for captured content, a context engine for creating names such as user friendly names associated with the captured content, and a tagging engine for associating the names with a data file or a group of data files containing the captured content. The tagging engine can dynamically associate the names as a data file name is created for the captured content. The context engine can include a voice tagging application that records a voice tag and converts the voice tag to text, wherein the tagging engine associates text with the data file or group of data files containing the captured content.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a picture voice cataloging system in accordance with an embodiment of the present invention.

FIG. 2 is an illustration of several use scenarios for the picture voice cataloging system of FIG. 1 in accordance with an embodiment of the present invention.

FIG. 3 is an illustration of existing naming syntax and the picture voice catalog naming syntax in accordance with an embodiment of the present invention.

FIG. 4 is a flow chart of a method of creating context aware groupings at the time of the data capture in accordance with an embodiment of the present invention.

FIG. 5 is a flow chart of a method of adding groupings to a calendaring system for use with a cataloging system in accordance with an embodiment of the present invention.

FIG. 6 is a flow chart of a method of creating subgroups within catalog groups in accordance with an embodiment of the present invention.

FIG. 7 is a flow chart illustrating a method of cataloging media files in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

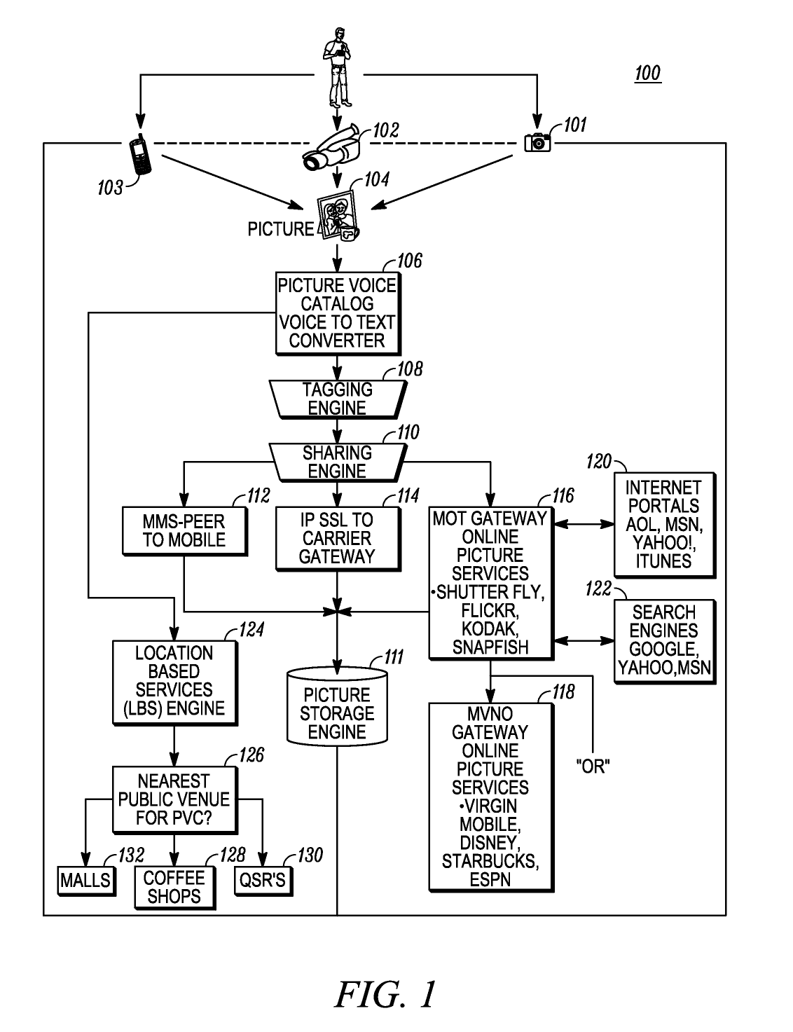

Embodiments herein can be implemented in a wide variety of exemplary ways. For example, the use of voice recoding capabilities in cellular digital phones can enable via the cellular phone microphone a speech input device interface using speech technologies such as codec libraries as well as VoiceXML and other speech technologies. By tying in the voice microphone to the cellular device “voice records” application, it can create a Picture Voice Catalog by changing a file name, from a somewhat cryptic looking name such as “B0002345.jpg” to a more user friendly and searchable name such as “johnny first birthday.jpg”. As illustrated in the system 100 of FIG. 1, when a camera 101, or video camera 102 or camera phone 103 first takes a picture 104, a voice Java applet “record picture name” for example can activate with a voice button to give a user the opportunity to voice record the name of the picture file as a file name. Thus, the picture is saved into the users chosen file name “johnny first birthday.jpg” in a picture storage engine or database 111 by using a voice to text converter 106 and a tagging engine 108. The tagging engine 108 can also operate cooperatively with a sharing engine 110 that enables access, storage, and easy retrieval of the picture(s) 104 with any number of third parties or services. For example, the sharing engine 110 can enable transmission of multimedia using a multimedia peer to mobile gateway 112 or an IP secure sockets layer to carrier gateway 114 or other proprietary gateways 116 or 118. The gateways can also be linked to Internet portals 120 such as AOL, MSN, YAHOO! or iTUNES and also linked to search engines 122 such as Google, Yahoo, or MSN. Additionally, the ability to group those pictures at the moment taken would enable users to create picture catalogs, e.g., “johnny first birthday party.jpg”. Embodiments herein can also utilize location based services 124 that can make queries 126 for the nearest public venues to tag files with location based meta-data or other data from predetermined or known locations 128 (coffee shop), 130 (quick service restaurant (QSR) location) or 132 (mall). By using cataloging techniques herein, it will save the user from having to rename pictures with a personal computer but will help users by having file names and catalogs file names that are familiar to the user or other interested parties that can then be searchable through search utilities (e.g., X1 Technologies), for easy picture catalog and pictures retrieval.

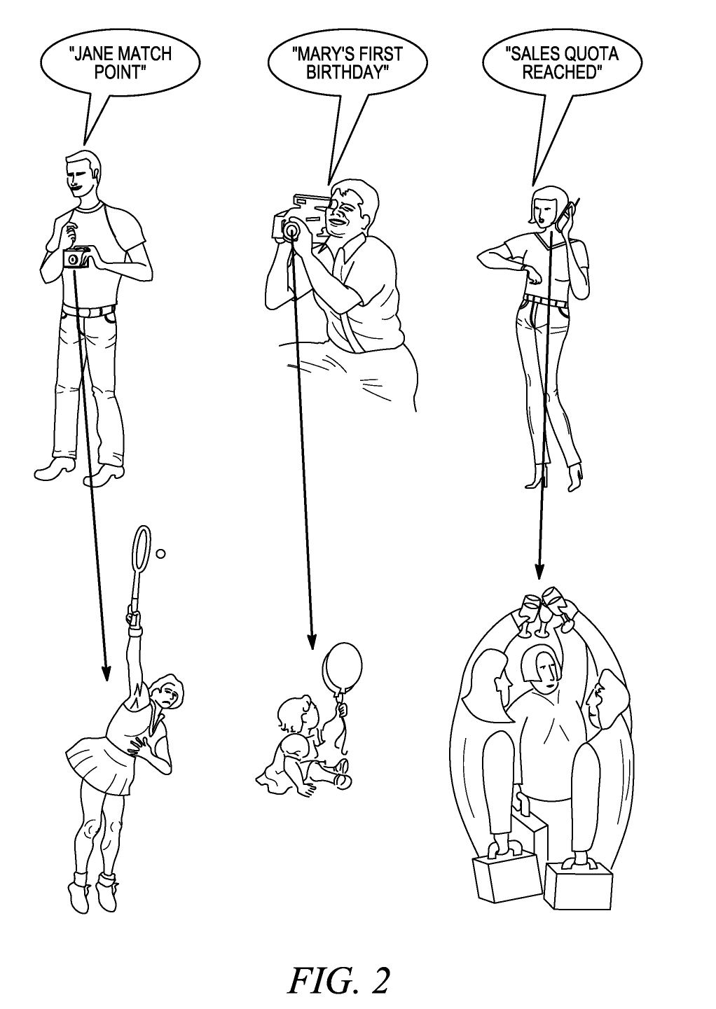

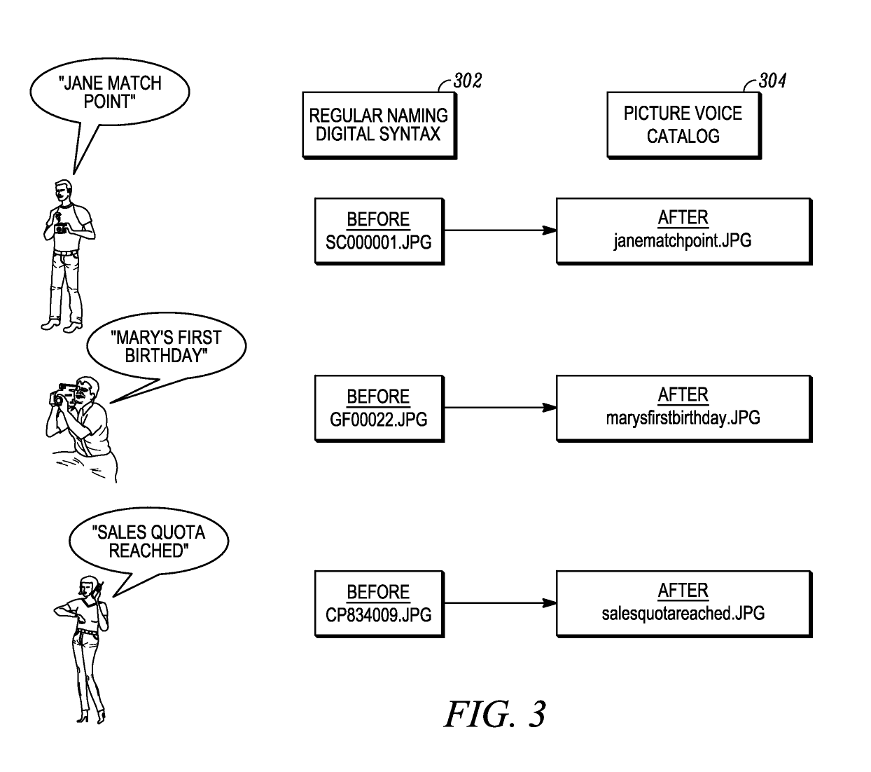

Referring to FIGS. 2 and 3, in a voice cataloging embodiment, as a user takes a picture, or a video, or is listening to or recording sound, a voice tag can be appended to the file corresponding to the picture, video, or sound recording. As noted in FIG. 3, the regular naming digital syntax 302 that is currently used (e.g., SC0000001.JPG, GF00022.JPG, or CP834009.JPG, can be replaced with janematchpoint.jpg, or marysfirstbirthday.jpg, or salesquotareached.jpg or such text can be appended as searchable metadata to such files. In one embodiment, VoiceXML can be used to create voice pictures catalogs. For example, cellular voice technology can be used to record inputs or commands like a voice command for a picture name for replacing a generic name like SC0001.jpg via a VoiceXML command “johnny_birthday_at_park” which will provide file name johnnybirthdayatpark.jpg. Generally, such a system offers accurate transcription of arbitrary speech. Currently available systems offer approximately 95% accuracy where very good microphones, extensive “training” against the user's voice reading known content, and a quiet background are typically used to maintain such accuracy. Although embodiments herein assume a transcription systems, a grammar-based approach can also be used having sufficient sentence patterns coded or stored.

The contextual information associated with such files can take on many forms. For example, such forms can be the naming of files, providing file metadata or altering the color of a folder based on user emotional state (e.g., sad, angry, mad, happy) based on voice and/or physiological data. Images or other files can be searched based on emotional state so that a user can “re-live” the experience. Files and folders can be categorized based on emotional state. For example, a folder could be colored red to indicate anger while blue could be used to indicate file types that are calm.

The naming of files or metadata can also be based on user devices that are within geographic range when the file is created. For example, a media capturing device can capture another user's Bluetooth friendly name or a friendly name or alias given to a MAC address as part of the file name or metadata. The naming of files or metadata can also utilize voice, face or object recognition where the capturing device identifies individuals, icons, insignias, text or other objects in a crowd. Information from an address book can also be used and incorporated as part of the filename or metadata. Thus, an address book entry or other content can be linked to a filename or metadata.

Naming of files or metadata based on temporal and/or spatial boundaries can also provide useful context information. For example, a soccer game on a calendar from 2 to 4 pm can enable all pictures take from 2 to 4 pm to automatically get an additional filename or metadata of “soccer”. Also, if during this period the person has a wait between periods of active picture capturing, the different periods can be captured and cataloged in a way to show that they belong to the soccer category but yet can belong to other groups or be disjoint from groups with the soccer category. In another aspect, an appointment added later can cause the application to go back and alter a filename, metadata, folder attributes or other data that occurred during the time of the calendar appointment. For example, after taking pictures at a soccer game, retroactively adding a past calendar event into the calendar can tag new attributes to pictures already stored or taken.

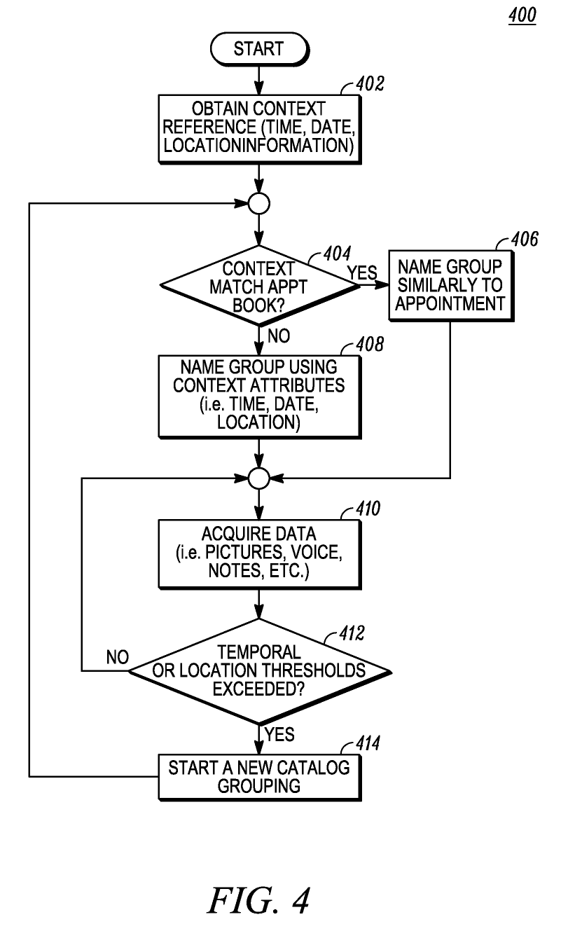

Referring to FIG. 4, a flow chart illustrates a method 400 where temporal and spatial (location) characteristics of a data-gathering activity can be used to automatically create a catalog grouping. At step 402, a context reference such as a time, date, and/or location can be obtained. At decision block 404 a determination can be made whether the context matches a calendar or appointment book. If a match exists, the group created can have a name similarly given to the appointment at step 406. If no match exists at decision block 404, the group can be given a name using the contextual attributes currently obtained. The method can continue in acquiring data at step 410 such as pictures and voice notes and affiliating the group name with such data. In addition, the temporal or location threshold is monitored at decision block 412. If temporal or location thresholds are exceeded at decision block 412, a new catalog grouping can be created at step 414. If within the thresholds, the data can continue to be acquired having the pre-existing group affiliation.

The means to obtain context information is well known in the art such as GPS, reverse Geocoding, manual input, and the like. However, embodiments herein can uniquely set temporal/spatial thresholds programmatically or by deriving such thresholds from the location information itself or from the length of an appointment in a datebook or calendar. For example, the temporal threshold for a catalog that matches an entry in the user's appointment book can be the length of time of the meeting or if in a conference call, then the length of the call can be used as the threshold. For spatial thresholds, physical displacement can be bounded to a range that equals the perimeter or a predetermined distance from the perimeter of the location where the activity is taking place. Once again, the information can be easily obtained using commercial location and concierge services.

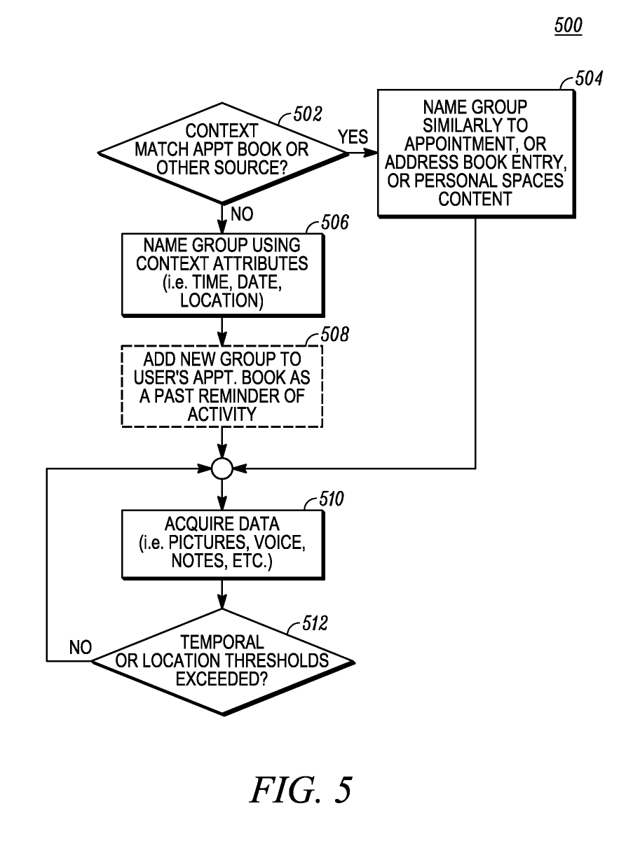

Optionally, when a new cataloging group is created that does not match an existing entry in a user's appointment book, a past appointment can be inserted into the datebook/appointment group as a reminder of a past activity. This entry can then be used as a reminder of a past activity to help identify the catalog group. Referring to method 500 of FIG. 5, if a match of context exists in an appointment book or some other source at decision block 502, then the name of the group can have a similar name to that of the appointment (or some other data from another source such as an address book or from personal spaces content (e.g., MySpace.com)) at step 504. If no match exists at decision block 502, a new group name can be given using current context attributes at step 506. The method 500 can similarly continue as described with method 400 where data is acquired at step 510 and temporal and location thresholds are monitored at step 512. Additionally, if a new group is added to a user's appointment book (retroactively) as a past reminder of activity, such new group addition will create or change corresponding context attributes that will be associated with pictures already associated with an existing time, date or location at step 508.

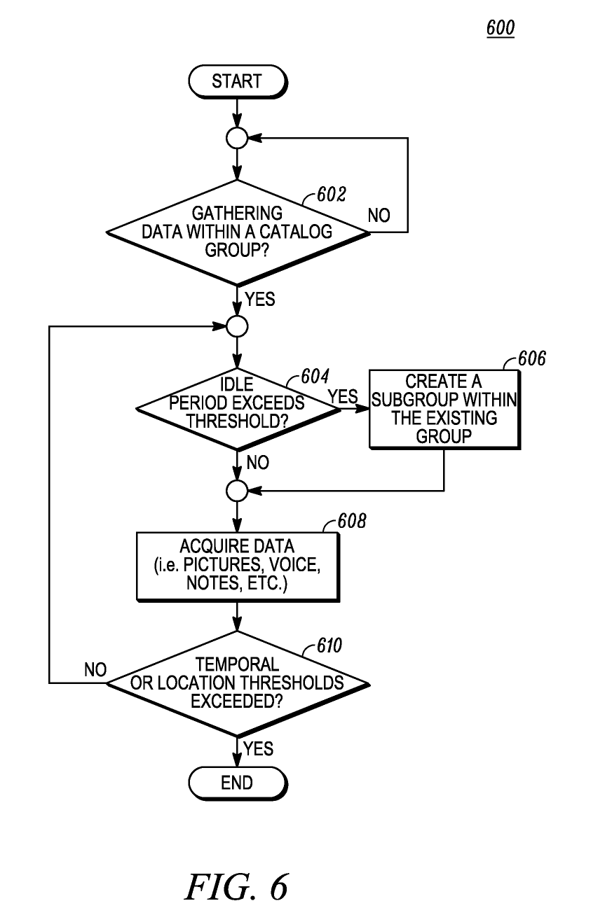

Another possible extension is the ability to create subgroups within a catalog group as illustrated in method 600 of FIG. 6. For example, if data gathering is idle as shown in decision block 602 for a period of time that exceeds a threshold as shown at decision block 604, but still within the time of an appointment, then a subgroup can be created within the existing group at step 606. If within the time of an appointment, then data is still acquired at step 608 and thresholds monitored at decision block 610. For example, during a 2-hour visit to the zoo, a user can photograph multiple animal exhibits with idle times in between the animal exhibits. Thus, idle time thresholds that are exceed between animal exhibits will create sub-groups. Alternatively, subgroups can be manually created by the user.

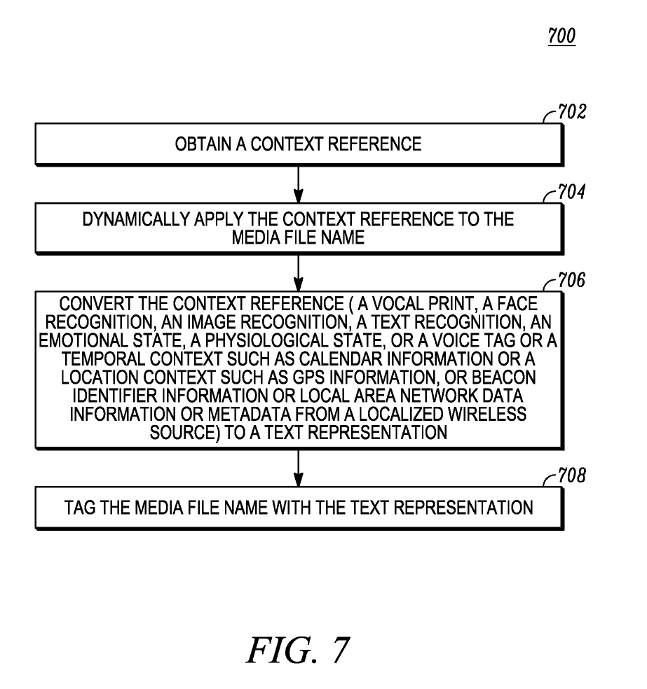

Referring to FIG. 7, a method 700 of cataloging a media file name can include obtaining a context reference at step 702 and dynamically applying the context reference to the media file name at step 704. The method 700 can further include the step 706 of converting the context reference to a text representation and tagging the media file name with the text representation at step 708. Obtaining the context reference can involve obtaining a voice print, a face recognition, an image recognition, a text recognition, an emotional state, a physiological state, or a voice tag. The context reference can also be inferred as well. For example, an emotional or physiological state can be inferred from music being listened to or content being accessed such as content from a personal space on the Internet. The context reference can also be a temporal context or a location context. The location context can be for example GPS information, or beacon identifier information or local area network data information or metadata from a localized wireless source.

The context reference can also be calendaring data where in one embodiment the calendaring data can be applied to the media file name if temporal or location values are within thresholds of the calendaring data and where other names (such as a default name) are applied to the media file name if temporal or location values exceed one or more thresholds of the calendaring data. Furthermore, a new context reference can be created and applied to a currently acquired media file if temporal or location values exceed one or more thresholds for the calendaring data. The method can also include the step of voice cataloging a currently acquired media file with a voice tag. The voice tag can be translated into text and applied to the media file name. Note, the media file name can be for a currently acquired data file for a picture file, a video file, or an audio file, but is not necessarily limited thereto. The method can further include the steps of creating a catalog group based on the context reference, using calendaring data to name the catalog group, optionally inserting a past appointment into the calendaring data to mark a past activity, and using temporal or spatial information to create subgroups within a catalog group.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of cataloging a media file name, comprising:
obtaining a context reference; and
dynamically applying the context reference to the media file name.

2. The method of claim 1, wherein the method further comprises converting the context reference to a text representation and tagging the media file name with the text representation.

3. The method of claim 1, wherein the step of obtaining the context reference comprises obtaining at least one among a voice print, a face recognition, an image recognition, a text recognition, an emotional state, a physiological state, or a voice tag.

4. The method of claim 1, wherein the step of obtaining the context reference comprises obtaining a temporal context or a location context.

5. The method of claim 4, wherein the step of obtaining the location context comprises obtaining GPS information, or beacon identifier information or local area network data information or metadata or Bluetooth friendly names from a localized wireless source.

6. The method of claim 1, wherein the step of obtaining the context reference comprises obtaining calendaring data.

7. The method of claim 6, wherein the method further comprises the step of applying the calendaring data to the media file name if temporal or location values are within thresholds of the calendaring data and applying other names to the media file name if temporal or location values exceed one or more thresholds of the calendaring data.

8. The method of claim 6, wherein the method further comprises the step of creating a new context reference and applying the new context reference to a currently acquired media file if temporal or location values exceed one or more thresholds for the calendaring data.

9. The method of claim 1, wherein the method further comprises the step of voice cataloging a currently acquired media file with a voice tag.

10. The method of claim 9, wherein the method further comprises the step of translating the voice tag to text and applying the voice tag in text form to the media file name.

11. The method of claim 1, wherein the method further comprises the steps of:
creating a catalog group based on the context reference;
using calendaring data to name the catalog group;
optionally inserting a past appointment into the calendaring data to mark a past activity; and
using temporal or spatial information to create subgroups within a catalog group.

12. A system for capturing and cataloguing media filenames, comprising:
a media capturing device;
a context input device for a providing a context value associated with at least one media file;
a processor coupled to the context input device, wherein the processor is programmed to apply the context value to a media filename or a group of media filenames.

13. The system of claim 12, wherein the media capturing device comprises a digital camera, a digital audio recording device, a digital video camera, a camera phone, or a portable computing device with any combination thereof.

14. The system of claim 12, wherein the context input device comprises a voice capturing device and the system further comprises a voice to text converter and tagging engine for tagging textual representations of captured voice associated with media captured by the media capturing device.

15. The system of claim 12, wherein the context input device comprises a voice recognition device, an image recognition device, an optical character recognition device, an emotional state monitor, or a physiological state monitor.

16. The system of claim 12, wherein the context input device comprises a temporal and location capturing device or a calendaring device coupled to the processor.

17. The system of claim 12, wherein the context input device comprises a GPS receiver, a beacon receiver, or a local area network receiver.

18. A media capturing device, comprising:
an image or sound capturing device that creates data files for captured content;
a context engine for creating names associated with the captured content; and
a tagging engine for associating the names with a data file or a group of data files containing the captured content.

19. The media capturing device of claim 18, wherein the tagging engine dynamically associates the names as a data file name is created for the captured content.

20. The media capturing device of claim 18, wherein the context engine comprises a voice tagging application that records a voice tag and converts the voice tag to text, wherein the tagging engine associates text with the data file or group of data files containing the captured content.
